(19) United States
(12) Patent Application Publication
(10) Pub. No.: US 2026/0075003 A1
(43) Pub. Date: Mar. 12, 2026

(54) TRANSFER DEVICE, TRANSFER METHOD, AND COMPUTER READABLE MEDIUM

(71) Applicant: Mitsubishi Electric Corporation, Tokyo (JP)

(72) Inventors: Ryuma MATSUSHITA, Tokyo (JP); Sachiko TANIGUCHI, Tokyo (JP); Makoto KUBOMI, Tokyo (JP)

(73) Assignee: Mitsubishi Electric Corporation, Tokyo (JP)

(21) Appl. No.: 19/388,808

(22) Filed: Nov. 13, 2025

Related U.S. Application Data
(63) Continuation of application No. PCT/JP2023/024930, filed on Jul. 5, 2023.

(51) Int. Cl. H04L 47/24

(52) U.S. Cl. CPC H04L 47/24

(57) ABSTRACT

A transfer device (10) transfers a received frame. A frame identification unit (121) assigns a corresponding identifier to a received frame based on content of the received frame. An allocation unit (122) stores a received frame in a reception queue (123) corresponding to an identifier assigned to the received frame. A reception gate control unit (124) executes a reception gate control process of reading a received frame from the reception queue (123) based on a gate control setting that is set by a setting unit (104) so as to cause a received frame that has violated a communication cycle to wait in a reception queue.

### CROSS REFERENCE TO RELATED APPLICATION

This application is a Continuation of PCT International Application No. PCT/JP2023/024930, filed on Jul. 5, 2023, which is hereby expressly incorporated by reference into the present application.

### TECHNICAL FIELD

The present disclosure relates to a transfer device, a transfer method, and a transfer program.

### BACKGROUND ART

IEEE 802.1Q-2018 specifies TAS. TAS is an abbreviation for time-aware shaper. TAS is a specification for transfer devices for securing the transmission quality of each communication stream in a network where communication streams of different required quality levels coexist. In TAS, scheduled transfers based on time that is synchronized within a network are performed. However, if a communication stream that violates a communication cycle defined at a network design stage occurs, a scheduled transfer by TAS fails. To solve this problem, IEEE 802.1Q-2018 also specifies PSFP as a specification for discarding a communication stream that has violated a communication cycle at the time of reception in a transfer device. PSFP is an abbreviation for per-stream filtering and policing.

IEEE 802.1Q-2018 also specifies FP as a specification for transfer devices for ensuring that delays do not occur in high-priority communication streams. FP is an abbreviation for frame preemption. In FP, if a transfer request for a high-priority frame requiring low-delay transfer occurs during transfer of a low-priority frame not requiring low-delay transfer, the transfer of the low-priority frame is interrupted and divided so as to transfer the high-priority frame by interrupt transfer, thereby reducing a transfer delay of the high-priority frame. After the transfer of the high-priority frame is completed, the low-priority frame divided by the interrupt transfer is transferred so as to be combined and restored to the frame before being divided at a transfer device on the reception side.

### CITATION LIST

### Non-Patent Literature

Non-Patent Literature 1: IEEE 802.1Q-2018-IEEE Standard for Local and Metropolitan Area Networks—Bridges and Bridged Networks

### SUMMARY OF INVENTION

### Technical Problem

When the transfer device supports PSFP, the transmission quality of communication streams that do not violate the cycle is secured. However, communication streams that violate the cycle are simply discarded without securing transmission quality. To prevent terminals from violating the cycle of communication streams, it is necessary to highly accurately synchronize time between the terminals and perform advanced transmission timing control using the synchronized time. However, the advanced transmission timing control using the synchronized time generally increases terminal costs. If terminals that can highly accurately control transmission timing cannot be used, a problem in transfer control by PSFP is that the transmission quality of communication streams with large transmission timing errors cannot be secured.

An object of the present disclosure is to ease required accuracy of transmission timing synchronization between terminals so as to reduce terminal costs.

### Solution to Problem

A transfer device according to the present disclosure includes
a frame identification unit to assign a corresponding identifier to a received frame based on content of the received frame;
an allocation unit to store a received frame in a reception queue corresponding to an identifier assigned to the received frame;
a setting unit to set a gate control setting to set open/close information of a reception queue, the gate control setting being set for causing a received frame that has violated a communication cycle to wait in the reception queue; and
a reception gate control unit to execute a reception gate control process of reading a received frame from the reception queue based on the gate control setting.

### ADVANTAGEOUS EFFECTS OF INVENTION

In a transfer device according to the present disclosure, a received frame is read from a reception queue based on a gate control setting that causes a received frame that has violated a communication cycle to wait in a reception queue. Therefore, with the transfer device according to the present disclosure, transmission timing errors of terminals are absorbed in the transfer device, so that it is possible to ease required accuracy of transmission timing synchronization between terminals and contribute to reduction in terminal costs.

### BRIEF DESCRIPTION OF DRAWINGS

FIG. 1 is a diagram illustrating failure of a scheduled transfer by TAS.

FIG. 2 is a diagram illustrating an overview of the operation of a transfer device that supports PSFP.

FIG. 3 is a diagram illustrating an example of the functional configuration of a transfer device according to Embodiment 1.

FIG. 4 is a diagram illustrating an example of the overall configuration of a transfer system and an overview of the operation of the transfer device according to Embodiment 1.

FIG. 5 is a diagram illustrating an example of the structure of gate control settings according to Embodiment 1.

FIG. 6 is a diagram illustrating an example of gate open/close operations based on the gate control settings according to Embodiment 1.

FIG. 7 is a diagram illustrating an example of the hardware configuration of the transfer device according to Embodiment 1.

FIG. 8 is a diagram illustrating another example of the hardware configuration of the transfer device according to Embodiment 1.

FIG. 9 is a diagram illustrating an example of the functional configuration of the transfer device according to Embodiment 2.

### DESCRIPTION OF EMBODIMENTS

Embodiments of the present disclosure will be described hereinafter with reference to the drawings. In the drawings, the same or corresponding parts are denoted by the same reference signs. In the description of the embodiments, description of the same or corresponding parts will be suitably omitted or simplified. In the drawings hereinafter, the relative sizes of components may be different from actual ones. In the description of the embodiments, directions or positions such as “up”, “down”, “left”, “right”, “front”, “rear”, “top side”, and “back side” may be indicated. These terms are used only for convenience of description, and are not intended to limit the placement and orientation of components such as devices, equipment, or parts.

### Embodiment 1

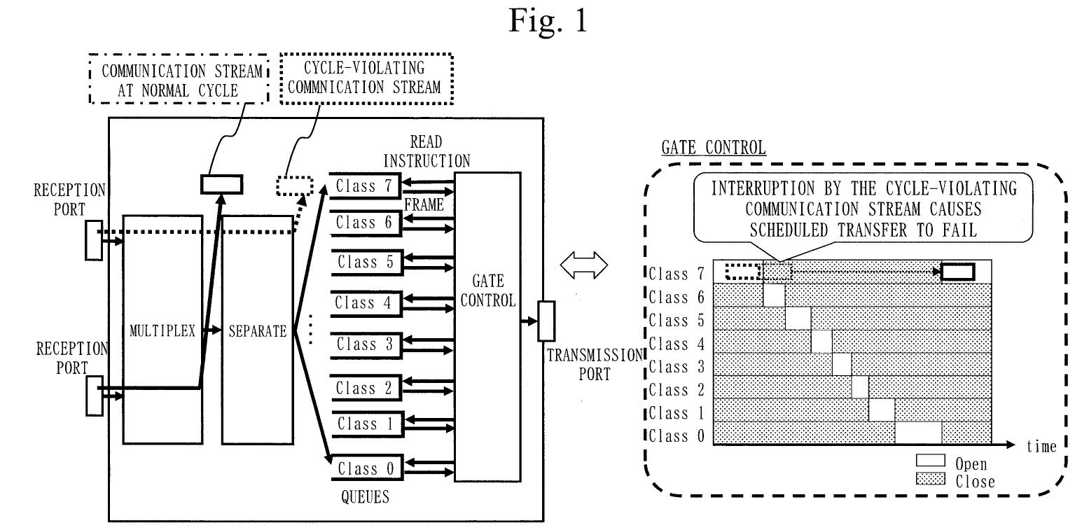

FIG. 1 is a diagram illustrating failure of a scheduled transfer by TAS.

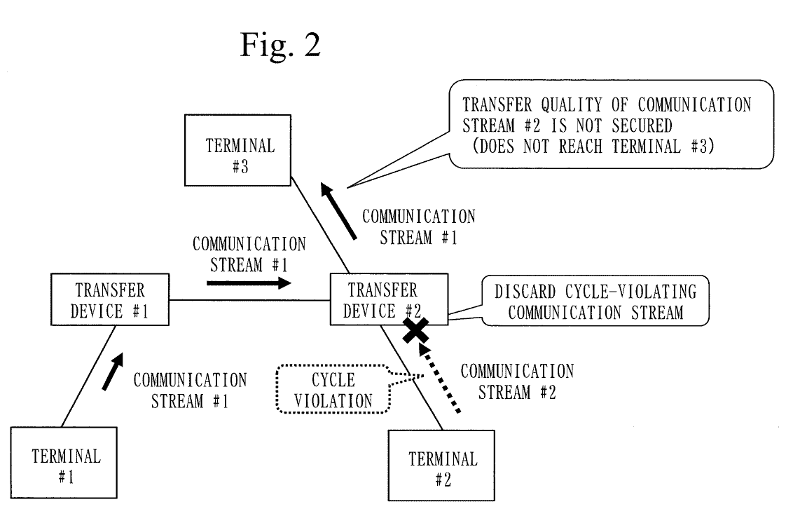

FIG. 2 is a diagram illustrating an overview of the operation of a transfer device that supports PSFP.

FIGS. 1 and 2 illustrate examples of the transfer device that forms the basis of this embodiment.

In the TAS illustrated in FIG. 1, scheduled transfers are performed based on time synchronized within a network. However, as illustrated in FIG. 1, if a communication stream that violates a communication cycle defined at a network design stage occurs, a scheduled transfer by the TAS fails.

As illustrated in FIG. 2, when the transfer device supports PSFP, the transmission quality of a communication stream #1, which has not violated the cycle, is secured. However, a communication stream #2, which has violated the cycle, is simply discarded without securing transmission quality.

### Description of Configuration

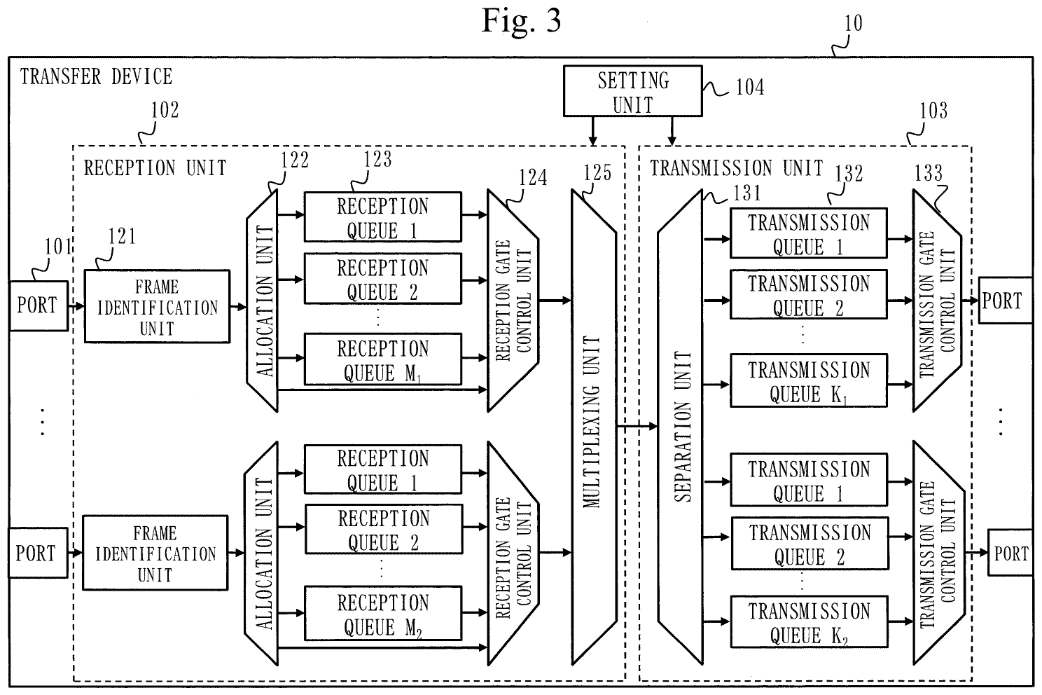

FIG. 3 is a diagram illustrating an example of the functional configuration of a transfer device 10 according to this embodiment.

As illustrated in FIG. 3, the transfer device 10 includes a port 101, a reception unit 102, a transmission unit 103, and a setting unit 104.

The reception unit 102 includes a frame identification unit 121, an allocation unit 122, a reception queue 123, a reception gate control unit 124, and a multiplexing unit 125.

The transmission unit 103 includes a separation unit 131, a transmission queue 132, and a transmission gate control unit 133.

Note that the number of each of these functional blocks need not be limited to the number indicated in FIG. 3, and the number of each functional block may be more or less than the number indicated in FIG. 3.

### Description of Operation

The operation of the transfer device 10 according to this embodiment will now be described. A procedure for the operation of the transfer device 10 is equivalent to a transfer method. A program that realizes the operation of the transfer device 10 is equivalent to a transfer program.

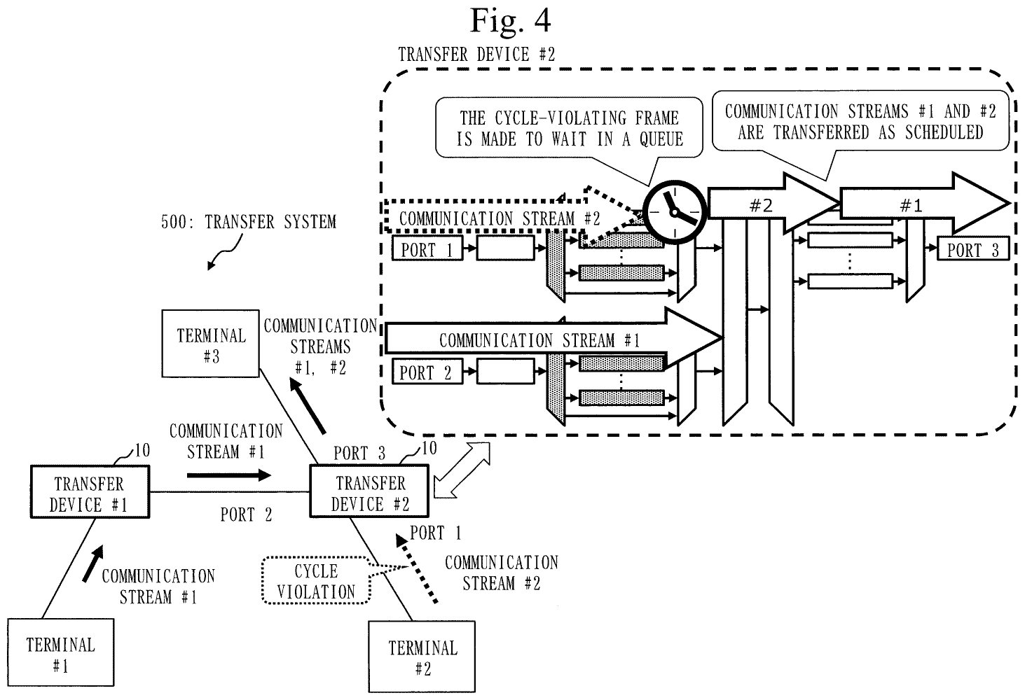

FIG. 4 is a diagram illustrating an example of the overall configuration of a transfer system 500 and an overview of the operation of the transfer device 10 according to this embodiment.

As illustrated in FIG. 4, in the transfer system 500, each transfer device transfers a communication stream that is transmitted and received between terminals.

In a transfer system of FIG. 2, the communication stream #2 that has violated the cycle is discarded without securing transmission quality.

On the other hand, in the transfer system 500 according to this embodiment, the transfer device 10 causes a cycle-violating frame to wait in a queue, so that the communication stream #1 and the communication stream #2 can be transferred as scheduled.

The port 101 transfers a received frame received from an external device to the frame identification unit 121.

The frame identification unit 121 assigns a corresponding identifier to the received frame based on the content of the received frame received from the port 101. The identifier is uniquely determined by pattern matching between attributes of the received frame and settings obtained from the setting unit 104. The attributes of the received frame are attributes such as a reception port number, header information, payload information, and error information of the received frame.

The setting unit 104 sets setting information for determining identifiers.

The setting unit 104 also sets gate control settings.

The setting unit 104 can also set a type of one of a branch port and a trunk port for each port that receives received frames.

The setting information is, for example, a setting such as assigning ID=1 when the destination MAC address of a received frame received at a port number 1 is “12-34-56-AB-CD-EF” and EtherType is “0x0800” (IP communication). MAC is an abbreviation for media access control. IP is an abbreviation for internet protocol. ID is an abbreviation for identifier.

In this case, the frame identification unit 121 determines whether a received frame is a frame that matches the above setting, and assigns ID=1 to the received frame if a match occurs.

The identifier may be assigned to the received frame by temporarily replacing part of the content of the frame within the transfer device. Alternatively, a signal indicating the identifier may be transmitted separately from the received frame and in parallel with the received frame to a subsequent functional block.

Identification conditions may be set by a user in the setting unit 104 as described above, or identification conditions may be statically recorded in the frame identification unit 121.

Gate setting control and setting of a port type will be described later.

The allocation unit 122 receives the received frame from the frame identification unit 121. Based on the identifier assigned to the received frame by the frame identification unit 121, the allocation unit 122 transfers the received frame to the reception queue 123 corresponding to the identifier.

Specifically, if the transfer device 10 has a reception queue corresponding to the identifier assigned to the received frame, the allocation unit 122 stores the received frame in the corresponding reception queue. On the other hand, if the transfer device 10 does not have a corresponding reception queue, the received frame is transmitted to the reception gate control unit 124. That is, if the transfer device 10 does not have a corresponding reception queue, typical PSFP processing is performed.

The reception queue 123 temporarily accumulates received frames received from the allocation unit 122. The reception queue 123 transmits information on the presence or absence of accumulated frames and the frame length of a frame at the top of the queue to the reception gate control unit 124. It is not necessary to provide one reception queue for each identifier. For example, by associating multiple identifiers with one reception queue, there may be fewer reception queues than the number of identifiers that can be set in the transfer device 10.

A transfer device equipped with an FP function usually has a reception queue for combining divided frames, and the reception queue used for the FP function may be used as the reception queue 123.

The reception gate control unit 124 executes a reception gate control process of reading received frames from the reception queue 123 based on the gate control settings set in the setting unit 104. If frames are accumulated in the reception queue 123, the reception gate control unit 124 reads the frames from the reception queue 123 based on the gate control settings.

Specifically, as the reception gate control process, the reception gate control unit 124 selects one of an operation of queuing and an operation of discarding based on a difference between the gate control settings and the arrival timing of a received frame. That is, transferring or discarding is selected depending on to what degree the cycle is violated.

As the gate control settings, open/close information of the reception queues is set. The gate control settings are information for causing a received frame that has violated the communication cycle to wait in a reception queue.

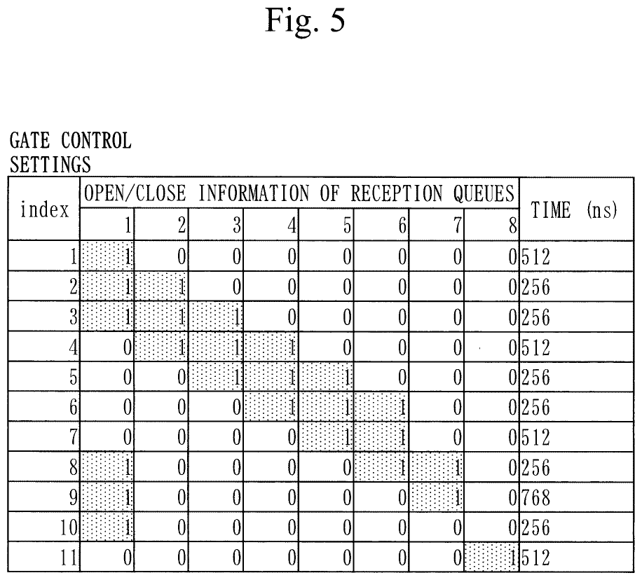

FIG. 5 is a diagram illustrating an example of the structure of the gate control settings according to this embodiment.

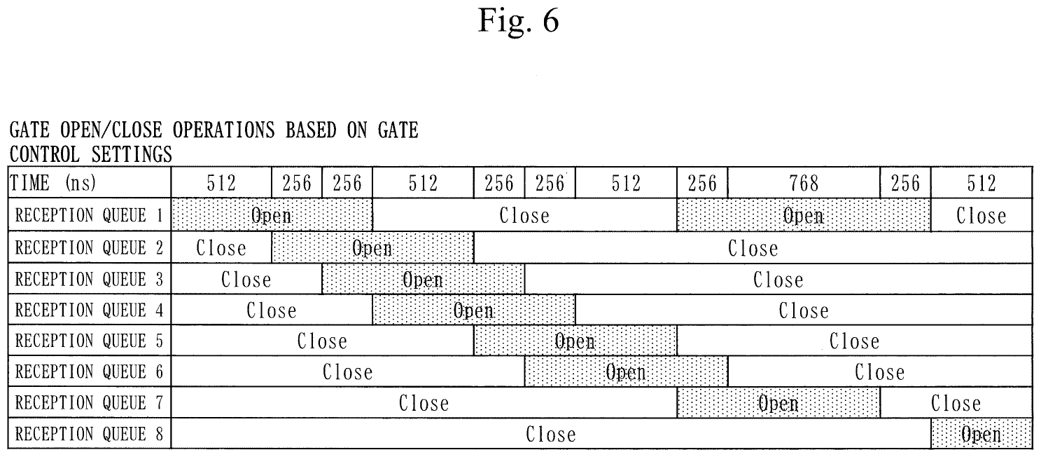

FIG. 6 is a diagram illustrating an example of gate open/close operations based on the gate control settings according to this embodiment.

The gate control settings are arranged in a list structure and composed of a list index, open/close information of the reception queues, and time.

The open/close information of the reception queues is open/close information for each reception queue, which is a value of 0 or 1. 0 indicates a state in which reading from the reception queue is prohibited. 1 indicates a state in which reading from the reception queue is permitted.

A setting value of time indicates a time period during which reading is permitted. A setting value of time is set to an integer value of nanoseconds, for example.

The gate control setting of index=1 in FIG. 5 indicates that reading from a reception queue 1 is permitted for 512 nanoseconds.

The reception gate control unit 124 refers to the gate control settings in ascending order of index numbers, reads frames from only a reception queue from which reading is permitted at the current time, and transfers the frames to the multiplexing unit 125. If there are multiple reception queues from which reading is permitted, the reception queue from which reading is performed is determined according to a specific rule. Specifically, the reception gate control unit 124 repeats a process of reading received frames from the reception queue 1 for 512 ns of index=1, then reading received frames from the reception queues 1 and 2 for 256 ns of index=2, and so on.

The specific rule may be, for example, a strict priority rule or a round robin rule. The strict priority rule is a rule that prioritizes reading frames from reception queues in ascending order of queue numbers. The round robin rule is a rule that switches the reception queue from which reading is performed at regular intervals.

After referring to the gate control setting at the end of the list, the reception gate control unit 124 refers to the list again sequentially from the beginning.

If the transfer device 10 does not have a reception queue corresponding to the identifier, the allocation unit 122 transfers the received frame to the reception gate control unit 124 without storing the received frame in any reception queue 123.

The reception gate control unit 124 receives gate control settings for each identifier for received frames, which are similar to the gate control settings for each reception queue illustrated in FIG. 5, from the setting unit 104. The reception gate control unit 124 discards a frame that is prohibited from being read at the current time in the reception gate control unit 124. The gate control settings for each identifier for frames, which are similar to the gate control settings for each reception queue, specifically refer to settings such as how many seconds for a frame with ID=1, how many seconds for a frame with ID=2, and so on.

Referring to the gate control settings for each reception queue and referring to the gate control settings for each identifier for frames are executed in parallel.

The reception gate control unit 124 does not necessarily have to strictly follow time information in the gate control settings. The setting unit 104 may separately set time information indicating an allowable error, and if the current time is within the range of the allowable error compared to the time within the range in which reading is permitted, frames may be transferred without being discarded. If frames are accumulated in a reception queue even though the current time is outside the range of the allowable error compared to the time at which reading is permitted, the accumulated frames may be discarded without being transferred to the multiplexing unit 125. By taking into consideration such an allowable error, frames that clearly violate the cycle can be discarded, which yields the effect of reducing bandwidth usage in the network.

As described above, the reception gate control unit 124 causes a frame whose transmission timing from a terminal is not in accordance with the schedule, that is, not in accordance with the gate control settings, to wait in a reception queue until the time at which transfer is permitted by the control gate settings. This allows the transfer device to absorb a transmission timing error of the terminal, making it possible to ease the required accuracy for the terminal in synchronizing the transmission timing.

The setting unit 104 can set a type of one of a “branch port” and a “trunk port” for each port of the transfer device 10. The setting value of this port type is transmitted to the reception unit 102.

A “branch port” is, for example, a port connected to a terminal.

A “trunk port” is, for example, a port connected to another transfer device 10.

A port set as a branch port executes the reception gate control process described above, and a port set as a trunk port executes typical transfer control without executing the reception gate control process.

In a port set as a trunk port, a process in which the frame identification unit 121 assigns an identifier to be referred to by the allocation unit 122 is omitted. The allocation unit 122 transfers frames to the reception gate control unit 124, instead of storing the frames in the reception queue 123. The gate control process in the reception gate control unit 124 can also be omitted.

The reason for this is as follows. When the reception gate control process is performed at branch ports to absorb transmission timing errors of terminals, the normality of the transfer schedule for each communication stream is secured at the trunk port. Therefore, the trunk port does not need to perform processing to absorb transmission timing errors.

By omitting the reception gate control process at the trunk port, it is possible to obtain the effects of reducing computational costs and reducing transfer delays in communication steams in a trunk line.

The multiplexing unit 125 multiplexes multiple frames received from the reception gate control unit of each port. The separation unit 131 stores a received frame in the transmission queue 132 corresponding to the destination of the received frame. The transmission queue 132 and the transmission gate control unit perform scheduling transfer control in accordance with TAS specified in IEEE 802.1Q-2018.

### Description of Example of Hardware Configuration

The transfer device 10 is a computer. In the transfer device 10, the functions of the reception unit 102, the transmission unit 103, and the setting unit 104 are realized by hardware, software, firmware, or a combination of these.

### <Software Implementation>

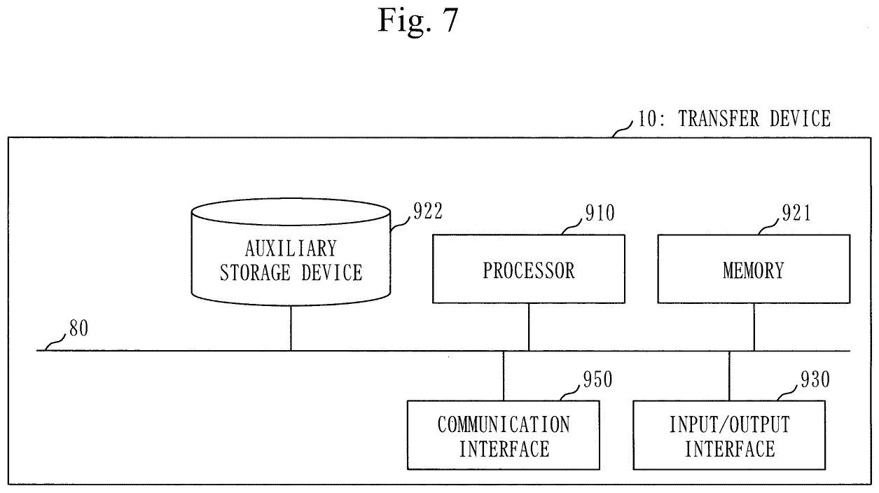

FIG. 7 is a diagram illustrating an example of the hardware configuration of the transfer device 10 according to this embodiment.

The transfer device 10 is a computer. The transfer device 10 includes a processor 910 and also includes other hardware components such as a memory 921, an auxiliary storage device 922, an input/output interface 930, and a communication interface 950. The processor 910 is connected to other hardware components through a signal line 80 and controls these other hardware components.

As described above, the transfer device 10 includes, as functional elements, the port 101, the reception unit 102, the transmission unit 103, and the setting unit 104. The functions of the reception unit 102, the transmission unit 103, and the setting unit 104 are realized by software. The functions of the reception unit 102, the transmission unit 103, and the setting unit 104 may be referred to as the functions of the transfer device 10. The reception unit 102, the transmission unit 103, and the setting unit 104 may be referred to as the units of the transfer device 10.

The processor 910 is a device that executes the transfer program. The transfer program is a program that realizes the functions of the transfer device 10.

The processor 910 is an integrated circuit (IC) that performs operational processing. Specific examples of the processor 910 are a CPU, a DSP, and a GPU. IC is an abbreviation for integrated circuit. CPU is an abbreviation for central processing unit. DSP is an abbreviation for digital signal processor. GPU is an abbreviation for graphics processing unit.

The memory 921 is a storage device to temporarily store data. Specific examples of the memory 921 are an SRAM and a DRAM. SRAM is an abbreviation for static random access memory. DRAM is an abbreviation for dynamic random access memory.

The auxiliary storage device 922 is a storage device to store data. A specific example of the auxiliary storage device 922 is an HDD. Alternatively, the auxiliary storage device 922 may be a portable storage medium, such as an SD (registered trademark) memory card, CF, a NAND flash, a flexible disk, an optical disc, a compact disc, a Blu-ray (registered trademark) disc, or a DVD. HDD is an abbreviation for hard disk drive. SD (registered trademark) is an abbreviation for Secure Digital. CF is an abbreviation for CompactFlash (registered trademark). DVD is an abbreviation for digital versatile disk.

The input/output interface 930 is an interface for connecting input and output devices. Specific examples of the input/output interface 930 are a USB port and an HDMI (registered trademark) port. USB is an abbreviation for Universal Serial Bus. HDMI (registered trademark) is an abbreviation for High-Definition Multimedia Interface.

The communication interface 950 is an interface for communicating with external devices. Specific examples of the communication interface 950 are an Ethernet (registered trademark) port and a device that performs wireless communication. The communication interface 950 is also referred to as data communication hardware.

The port 101 is realized by the communication interface 950.

The transfer program is executed in the transfer device 10. The transfer program is read into the processor 910 and executed by the processor 910. The memory 921 stores not only the transfer program but also an OS. OS is an abbreviation for operating system. The processor 910 executes the transfer program while executing the OS. The transfer program and the OS may be stored in the auxiliary storage device 922. The transfer program and the OS that are stored in the auxiliary storage device 922 are loaded into the memory 921 and executed by the processor 910. Part or the entirety of the transfer program may be embedded in the OS.

The transfer device 10 may include a plurality of processors as an alternative to the processor 910. The plurality of processors share execution of the transfer program. Each of the processors is a device that executes the transfer program, like the processor 910.

Data, information, signal values, and variable values that are used, processed, or output by the transfer program are stored in the memory 921 or the auxiliary storage device 922, or in a register or a cache memory within the processor 910.

Each unit of the transfer device 10 may be interpreted as “circuit”, “step”, “procedure”, “process”, or “circuitry”. The transfer program causes a computer to execute each process, where “unit” of each unit of the transfer device 10 is interpreted as “process”. “Process” of each process of the transfer device 10 may be interpreted as “program”, “program product”, “computer readable storage medium storing a program”, or “computer readable recording medium recording a program”. The transfer method is a method performed by execution of the transfer program by the transfer device 10.

The transfer program may be stored and provided in a computer readable recording medium. The transfer program may be provided as a program product.

### <Hardware Implementation>

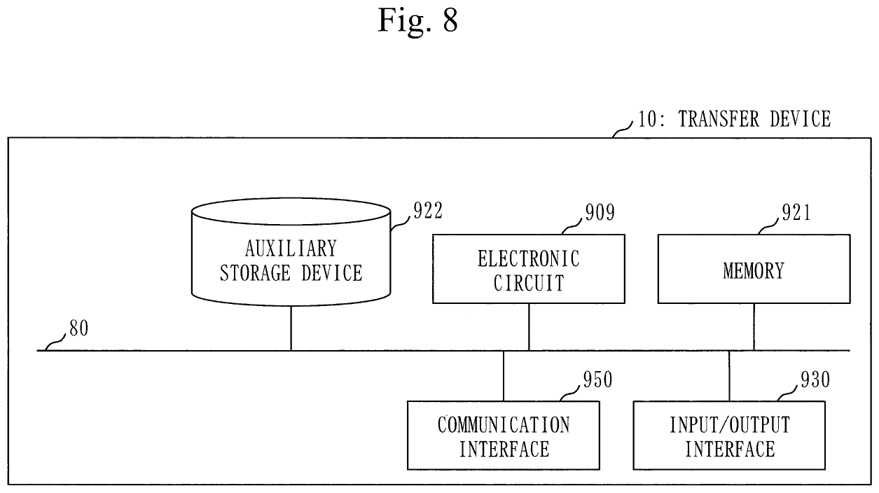

FIG. 8 is a diagram illustrating another example of the hardware configuration of the transfer device 10 according to this embodiment.

In this embodiment, the functions of the units of the transfer device 10 are realized by software. As a variation, the functions of the units of the transfer device 10 may be realized by hardware.

Specifically, the transfer device 10 includes an electronic circuit 909 in place of the processor 910.

The electronic circuit 909 is a dedicated electronic circuit that realizes the functions of the units of the transfer device 10. Specifically, the electronic circuit 909 is a single circuit, a composite circuit, a programmed processor, parallel-programmed processors, a logic IC, a GA, an ASIC, or an FPGA. GA is an abbreviation for gate array. ASIC is an abbreviation for application specific integrated circuit. FPGA is an abbreviation for field-programmable gate array.

The functions of the units of the transfer device 10 may be realized by one electronic circuit, or may be distributed among and realized by a plurality of electronic circuits.

As another variation, some of the functions of the units of the transfer device 10 may be realized by the electronic circuit, and the rest of the functions may be realized by software. Some or all of the functions of the units of the transfer device 10 may be realized by firmware.

Each of the processor and the electronic circuit is also referred to as processing circuitry. That is, the functions of the units of the transfer device 10 are realized by the processing circuitry.

### Description of Effects of This Embodiment

In the transfer device according to this embodiment, before multiplexing received frames in the transfer device, each frame is allocated to a corresponding reception queue. By causing a received frame to wait in a queue in accordance with the gate control settings, which are settings for scheduled transfers, it is possible to absorb transmission timing errors of devices and avoid failure of scheduled transfers after multiplexing.

Therefore, with the transfer device according to this embodiment, by absorbing transmission timing errors of devices such as terminals, it is possible to ease required accuracy in synchronizing transmission timing of devices and contribute to reduction in device costs.

### Embodiment 2

In this embodiment, differences from Embodiment 1 and additions to Embodiment 1 will be mainly described.

In this embodiment, components with substantially the same functions as those in Embodiment 1 are denoted by the same reference signs, and description thereof will be omitted.

### Description of Configuration

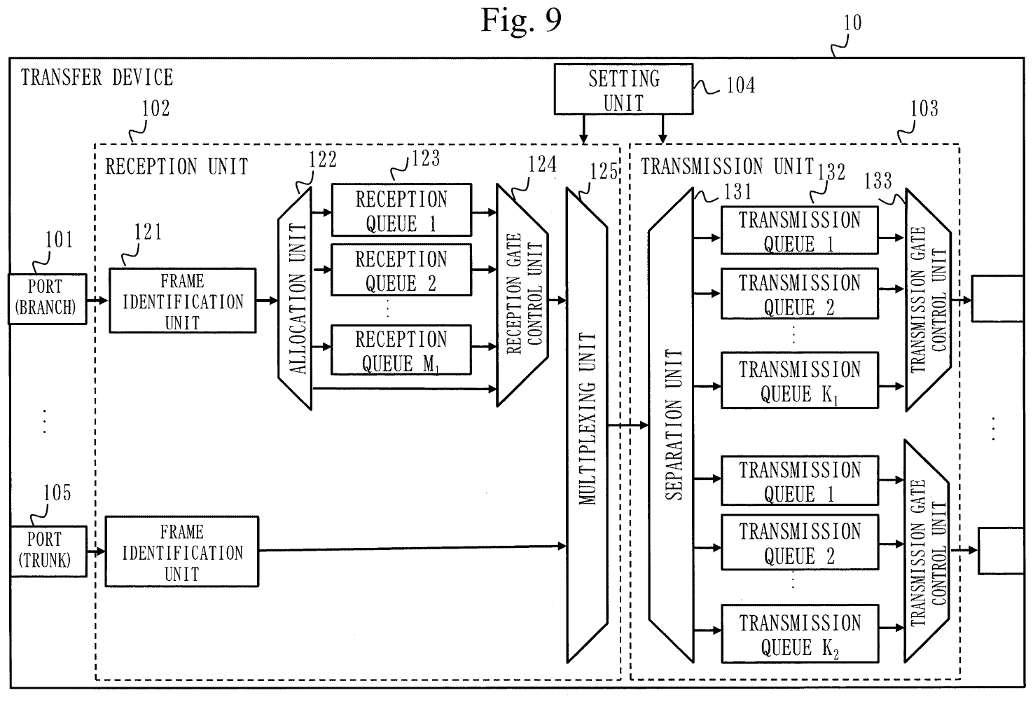

FIG. 9 is a diagram illustrating an example of the functional configuration of the transfer device 10 according to this embodiment.

In this embodiment, a configuration in which a terminal is connected to a specific port of the transfer device 10 will be described.

For example, the configuration is such that a terminal is connected to an electrical port of the transfer device 10, and another transfer device 10 is connected to an optical port of the transfer device 10.

When the ports to which terminals are connected are limited like this, it is sufficient that the reception gate control process is performed only at branch ports to which terminals are connected, as described in Embodiment 1.

It is sufficient to provide the allocation unit 122, the reception queue 123, and the reception gate control unit 124 only in specific ports, as illustrated in FIG. 9. In the case of FIG. 9, the port 101 corresponds to a branch port, and a port 105 corresponds to a trunk port. The operation of each unit of the transfer device 10 is substantially the same as in Embodiment 1.

### Description of Effects of This Embodiment

In the transfer device according to this embodiment, the device costs of the transfer device can be further reduced, in addition to the effects of Embodiment 1.

In Embodiments 1 and 2 above, each unit of the transfer device is described as an independent functional block. However, the configuration of the transfer device may differ from the configuration in the embodiments described above. The functional blocks of the transfer device may have any configuration, provided that the functions described in the above embodiments can be realized. The transfer device may be a system composed of a plurality of devices, instead of a single device.

Two or more parts of Embodiments 1 and 2 may be implemented in combination. Alternatively, one part of these embodiments may be implemented. These embodiments may be implemented partially or as a whole in any combination.

That is, in Embodiments 1 and 2, each embodiment can be freely combined, or any constituent element of each embodiment can be modified. Alternatively, any constituent element can be omitted in each embodiment.

The embodiments described above are essentially preferable examples, and are not intended to limit the scope of the present disclosure, the scope of applications of the present disclosure, and the scope of uses of the present disclosure. The embodiments described above can be modified in various ways as necessary. For example, a procedure described using a flowchart or a sequence diagram may be appropriately modified.

### REFERENCE SIGNS LIST

10: transfer device; 101: port; 102: reception unit; 103: transmission unit; 104: setting unit; 121: frame identification unit; 122: allocation unit; 123: reception queue; 124: reception gate control unit; 125: multiplexing unit; 103: transmission unit; 131: separation unit; 132: transmission queue; 133: transmission gate control unit; 500: transfer system; 909: electronic circuit; 910: processor; 921: memory; 922: auxiliary storage device; 930: input/output interface; 950: communication interface.

1. A transfer device comprising
processing circuitry to:
assign a corresponding identifier to a received frame based on content of the received frame;
store a received frame in a reception queue corresponding to an identifier assigned to the received frame;
set a gate control setting to set open/close information of a reception queue, the gate control setting being set for causing a received frame that has violated a communication cycle to wait in the reception queue; and
execute a reception gate control process of reading a received frame from the reception queue based on the gate control setting,
wherein when the transfer device includes a corresponding reception queue for an identifier assigned to a received frame, the processing circuitry stores the received frame in the corresponding reception queue, and when the transfer device does not include a corresponding queue, the processing circuitry transmits the received frame to the reception gate control process.

2. The transfer device according to claim 1,
wherein the processing circuitry sets setting information for determining an identifier, and
wherein the processing circuitry assigns a corresponding identifier based on pattern matching between attributes including a reception port number, header information, payload information, and error information of the received frame and the setting information.

3. The transfer device according to claim 1,
wherein as the reception gate control process, the processing circuitry selects one of an operation of queuing and an operation of discarding based on a difference between the gate control setting and arrival timing of a received frame.

4. The transfer device according to claim 2,
wherein as the reception gate control process, the processing circuitry selects one of an operation of queuing and an operation of discarding based on a difference between the gate control setting and arrival timing of a received frame.

5. The transfer device according to claim 1,
wherein the processing circuitry can set a type of one of a branch port and a trunk port for each port that receives a received frame, and
wherein a port set as a branch port executes the reception gate control process, and a port set as a trunk port executes general transfer control without executing the reception gate control process.

6. The transfer device according to claim 2,
wherein the processing circuitry can set a type of one of a branch port and a trunk port for each port that receives a received frame, and
wherein a port set as a branch port executes the reception gate control process, and a port set as a trunk port executes general transfer control without executing the reception gate control process.

7. A transfer method comprising:
assigning a corresponding identifier to a received frame based on content of the received frame;
performing an allocation step of storing a received frame in a reception queue corresponding to an identifier assigned to the received frame;
setting a gate control setting to set open/close information of a reception queue, the gate control setting being set for causing a received frame that has violated a communication cycle to wait in the reception queue; and
executing a reception gate control process of reading a received frame from the reception queue based on the gate control setting,
wherein in the allocation step, when a transfer device includes a corresponding reception queue for an identifier assigned to a received frame, the received frame is stored in the corresponding reception queue, and when the transfer device does not include a corresponding queue, the received frame is transmitted to the reception gate control process.

8. A non-transitory computer readable medium storing a transfer program that causes a computer to execute:
a frame identification process of assigning a corresponding identifier to a received frame based on content of the received frame;
an allocation process of storing a received frame in a reception queue corresponding to an identifier assigned to the received frame;
a setting process of setting a gate control setting to set open/close information of a reception queue, the gate control setting being set for causing a received frame that has violated a communication cycle to wait in the reception queue; and
a reception gate control process of reading a received frame from the reception queue based on the gate control setting,
wherein when a transfer device includes a corresponding reception queue for an identifier assigned to a received frame, the allocation process stores the received frame in the corresponding reception queue, and when the transfer device does not include a corresponding queue, the allocation process transmits the received frame to the reception gate control process.
